(19) United States
(12) Patent Application Publication
(10) Pub. No.: US 2017/0168147 A1
(43) Pub. Date: Jun. 15, 2017

(54) SYSTEM AND METHOD FOR CORRECTING SIGNAL OF ULTRASONIC SENSOR

(71) Applicant: Hyundai Mobis Co., Ltd., Seoul (KR)

(72) Inventors: Young Soo CHOI, Yongin-si (KR); Joung Ho HAN, Yongin-si (KR); Uhn Yong SHIN, Yongin-si (KR)

(21) Appl. No.: 15/339,349

(22) Filed: Oct. 31, 2016

(30) Foreign Application Priority Data
Dec. 10, 2015 (KR) 10-2015-0175828

(51) Int. Cl. G01S 7/52; G01S 15/93

(52) U.S. Cl. CPC G01S 7/52004; G01S 15/931; G01S 2015/932

(57) ABSTRACT

Provided are a system for correcting a signal of an ultrasonic sensor according to a current weather condition, and a method of operating the same. The system for correcting a signal of an ultrasonic sensor according to a weather condition includes: a user terminal configured to externally acquire information about an ambient condition at a current position of a vehicle (for example, current temperature, and current humidity, and current atmospheric pressure) from an external server; and a vehicle terminal configured to calculate a current sound absorption coefficient based on the current ambient condition, determine whether a signal correction of the ultrasonic sensor mounted in the vehicle is needed by comparing the calculated current sound absorption coefficient with a preset standard sound absorption coefficient, and correct a received ultrasonic signal transmitted by the ultrasonic sensor and reflected from an obstacle based on a result determined by the vehicle terminal.

### CROSS-REFERENCE TO RELATED APPLICATION

This application claims priority from and the benefit of Korean Patent Application No. 10-2015-0175828, filed on Dec. 10, 2015, which is hereby incorporated by reference for all purposes as if set forth herein.

### BACKGROUND

Field

Exemplary embodiments of the present invention relate to a system and method for correcting a signal of an ultrasonic sensor, and more particularly, to a system and method for correcting a signal of an ultrasonic sensor according to current weather conditions.

Discussion of the Background

Nowadays, a vehicle is provided with technologies for sensing environments inside and outside of the vehicle using various sensors for convenience of a driver. Among the sensors, a sensor for a parking assistant system (PAS) is mounted in most vehicles. Sensors for a PAS are mounted on front and rear bumpers of a vehicle to measure a distance between the vehicle and an obstacle positioned around the vehicle and provide the measured distance to a driver. Accordingly, the driver may conveniently check the distance between the vehicle and the obstacle around the vehicle, and also recognize an obstacle in a blind spot.

Generally, a sensor for a PAS may be provided using an ultrasonic sensor. An ultrasonic sensor is widely used for distance measurement because the sensor is inexpensive and has a relative powerful performance compared to other sensors and is also effectively used in a vehicle.

A general ultrasonic sensor used in a vehicle has a sensing range of 1.2 m at the most, but there has been a development and application of a long distance ultrasonic sensor having a sensing range of up to 3 m. Ultrasonic waves naturally have a linearity related with diffraction, in which the linearity is greater as the diffraction is less, and the diffraction tends to be less as a frequency becomes higher. Accordingly, a central frequency is increased from a frequency around 40 kHz to a frequency around 58 kHz so that a long distance ultrasonic sensor has a bigger directivity angle than an existing ultrasonic sensor and a propagation distance of sound waves is increased up to 6 m.

However, in a high frequency band, sound absorption in the atmosphere is increased according to a long distance propagation of sound waves. The sound absorption is determined by a sound absorption coefficient. The sound absorption coefficient is calculated by using a frequency and an ambient condition (including temperature, humidity, and atmospheric pressure).

The ultrasonic sensor does not sense a reflected signal having an amplitude smaller than that of a reference signal which is set for each vehicle type. For example, the sound absorption coefficient may be greatly increased based on temperature, humidity, and atmospheric pressure conditions, and attenuation of sound pressure according to a sensing range of an ultrasonic sensor increases as a propagation distance of sound waves increases and a frequency band gets higher.

As such, the increasing sound absorption coefficient allows a reflected signal to be reduced in amplitude, and thus prevents the reflected signal from being recognized by the ultrasonic sensor. Accordingly, there is a need for a technology which is capable of estimating a sound absorption coefficient based on the current ambient condition and correcting a signal of an ultrasonic sensor according to the calculated sound absorption coefficient when measuring distance using the ultrasonic sensor so that a sensing performance of the ultrasonic sensor is improved.

The above information disclosed in this Background section is only for enhancement of understanding of the background of the invention and, therefore, it may contain information that does not form the prior art that is already known in this country to a person of ordinary skill in the art.

### SUMMARY

Exemplary embodiments of the present invention is directed to a system and method of correcting a received signal of an ultrasonic sensor by using a sound absorption coefficient which is calculated based on a weather condition at a current position of a vehicle.

The technical objectives of the inventive concept are not limited to the above disclosure; other objectives may become apparent to those of ordinary skill in the art based on the following descriptions.

An exemplary embodiment of the present invention discloses a system for correcting a signal of an ultrasonic sensor according to a weather condition, including a user terminal and a vehicle terminal. The user terminal may be configured to externally acquire information about an ambient condition at a current position of a vehicle. The vehicle terminal may be configured to calculate a current sound absorption coefficient based on the current ambient condition, determine whether a signal correction of the ultrasonic sensor mounted in the vehicle is needed by comparing the calculated current sound absorption coefficient with a preset standard sound absorption coefficient, and correct a received ultrasonic signal transmitted by the ultrasonic sensor and reflected from an obstacle based on a result determined by the vehicle terminal.

An exemplary embodiment of the present invention discloses a system for correcting a signal of an ultrasonic sensor according to a weather condition, including a user terminal and a vehicle terminal. The user terminal may be configured to externally acquire information about a current ambient condition at a current position of a vehicle, calculate a current sound absorption coefficient based on the current ambient condition, and determine whether a signal correction of an ultrasonic sensor mounted in the vehicle is needed by comparing the calculated current sound absorption coefficient with a preset standard sound absorption coefficient. The vehicle terminal may be configured to correct a received ultrasonic signal transmitted by the ultrasonic sensor and reflected from an obstacle based on a result determined by the user terminal.

An exemplary embodiment of the present invention discloses a method of correcting a signal of an ultrasonic sensor according to a weather condition, including: externally acquiring, by a user terminal, information about a current ambient condition at a current position of a vehicle; calculating, by the user terminal or a vehicle terminal, a current sound absorption coefficient based on the acquired ambient condition information, and determining whether a signal correction of an ultrasonic sensor mounted in the vehicle is needed by comparing the calculated sound absorption coefficient with a preset standard sound absorption coefficient; and correcting, by the vehicle terminal, a received ultrasonic signal transmitted by the ultrasonic sensor and reflected from an obstacle based on a result of the determination.

It is to be understood that both the foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating sound absorption coefficients according to frequencies and ambient conditions;

FIG. 2 is a block diagram illustrating a system for correcting a signal of an ultrasonic sensor based on a weather condition according to an exemplary embodiment;

FIG. 3 is a diagram showing a sound pressure decrease curve according to a propagation distance of an ultrasonic wave;

FIGS. 4A and 4B are diagrams showing a standard sound pressure decrease curve and a current sound pressure decrease curve obtained using a preset standard sound absorption coefficient and a calculated current sound absorption coefficient according to an exemplary embodiment;

FIG. 5 is a diagram illustrating a sound pressure correction rate based on a distance according to an exemplary embodiment;

FIG. 6 is a diagram illustrating a result of an original received ultrasonic signal corrected based on a sound pressure correction rate according to an exemplary embodiment;

FIG. 7 is a block diagram illustrating a system for correcting a signal of an ultrasonic sensor based on a weather condition according to an exemplary embodiment; and

FIG. 8 is a flow chart showing a method of correcting a signal of an ultrasonic sensor based on a weather condition according to an exemplary embodiment.

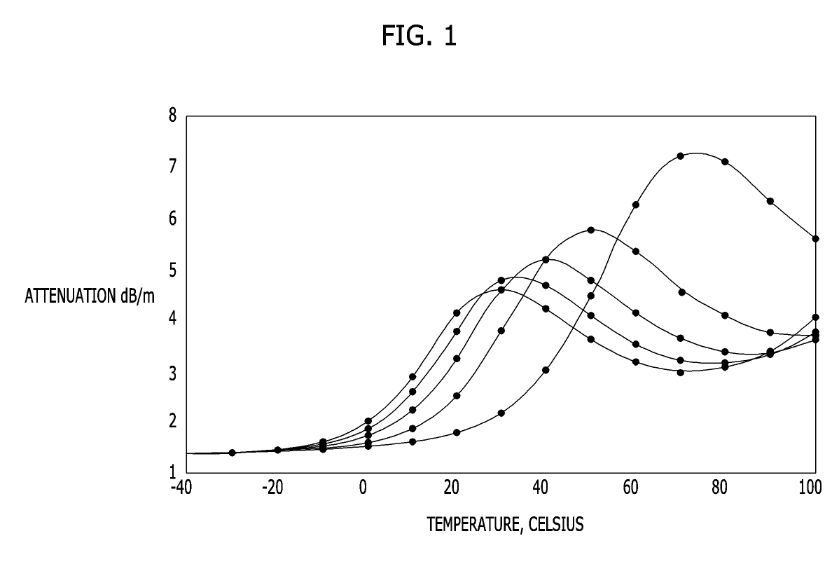

### DETAILED DESCRIPTION OF THE ILLUSTRATED EMBODIMENTS

Hereinafter, exemplary embodiments of the present invention will be described in detail with reference to the accompanying drawings. Throughout the specification, like reference numerals denote like elements having the same or similar functions. Detailed description of components or functions apparent to those skilled in the art will be omitted for clarity. It should be understood that the following exemplary embodiments are provided by way of example and that the present invention is not limited to the exemplary embodiments disclosed herein and can be implemented in different forms by those skilled in the art. It should be noted that the drawings are not to precise scale and may be exaggerated in thickness of lines or sizes of components for descriptive convenience and clarity only.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It should be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless defined otherwise, it is to be understood that all the terms (including technical and scientific terms) used in the specification has the same meaning as those that are understood by those who skilled in the art. Further, the terms defined by the dictionary generally used should not be ideally or excessively formally defined unless clearly defined specifically. It will be understood that for purposes of this disclosure, “at least one of X, Y, and Z” can be construed as X only, Y only, Z only, or any combination of two or more items X, Y, and Z (e.g., XYZ, XYY, YZ, ZZ). Unless particularly described to the contrary, the term “comprise”, “configure”, “have”, or the like, which are described herein, will be understood to imply the inclusion of the stated components, and therefore should be construed as including other components, and not the exclusion of any other elements.

The present invention relates to a technology for correcting a signal of an ultrasonic sensor according to a weather condition. An exemplary ultrasonic sensor will be described below. The exemplary ultrasonic sensor may be used with one or more of the various exemplary embodiments. An ultrasonic sensor calculates a propagation distance of an ultrasonic wave by using a Time of Flight (TOF) which is the time for a transmitted ultrasonic wave to be received by the ultrasonic sensor via reflection. A measured distance value is calculated by measuring a TOF until a point of time, at which a reflected wave returns after being reflected by an obstacle. The returned reflected wave must initially exceed a threshold level of a reference signal set for each type of vehicle.

When the received reflected signal propagates in the air, attenuation due to sound absorption may occur. The attenuation due to sound absorption may increase as a propagation distance of an ultrasonic wave increases. In particular, the attenuation due to sound absorption may vary with weather conditions, and may greatly increase as a frequency increases. For example, a sound absorption coefficient may be greatly increased depending on temperature, humidity, and atmospheric pressure conditions, and in this case, the amplitude of a reflected signal is reduced and is therefore not recognized by an ultrasonic sensor. In other words, the returned reflected wave does not exceed the threshold level.

In order to prevent the above situation, a different reference signal may be set for each ambient condition, but this requires an effort to find out various reference signals according to different ambient conditions.

According to an exemplary embodiment, a reflected ultrasonic wave signal is corrected by using a sound absorption coefficient corresponding to a current ambient condition so that only a single reference signal is used.

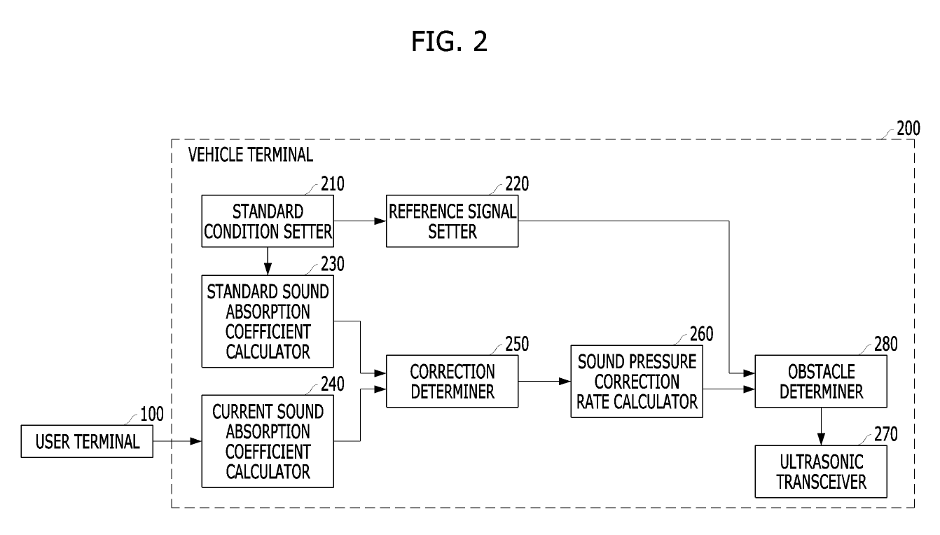

FIG. 2 is a block diagram illustrating a system for correcting a signal of an ultrasonic sensor based on a weather condition according to an exemplary embodiment.

Referring to FIG. 2, a system for correcting a signal of an ultrasonic sensor based on a weather condition according to an exemplary embodiment may include a user terminal 100 and a vehicle terminal 200.

The user terminal 100 acquires weather information at a current position from an external server. The user terminal 100 may be a mobile communication terminal (for example, a smartphone) possessed by a driver of a vehicle, and the weather information may be ambient condition information including at least one of a current temperature, a current humidity, and a current atmospheric pressure.

In detail, the user terminal 100 receives information about a current position from a global positioning system (GPS) satellite and acquires information about a current ambient condition corresponding to coordinates of the received current position from an external server. For example, the user terminal 100 may receive information about a current position from a GPS module, and acquire information about a current ambient condition at the current position from an external server (not shown) by using the received information about the current position. In this case, the user terminal 100 may acquire the information about the current ambient condition from the external server via a mobile communication, such as 3G and long term evolution (LTE), or a wireless communication network, such as Wi-Fi.

The external server may be a server of a meteorological administration which is in charge of providing national weather conditions. The external server may be a server of a weather observation station adjacent to a current position.

As an example, the user terminal 100 may have an application program (APP) installed therein for providing a real-time weather information service, and may acquire information about a current ambient condition at a current position through a real-time weather information service application. As another example, the user terminal 100 may have an application program installed therein for interoperating with a navigation system of a vehicle to acquire ambient condition information corresponding to a current position of the vehicle which is identified by the navigation system through a server of a weather observation station.

In addition, it should be understood that the user terminal 100 may acquire information about a current ambient condition at a current position through various application programs which provide weather condition information.

The user terminal 100 provides the vehicle terminal 200 with the ambient condition information at the current position acquired through at least one of the various methods described above. The vehicle terminal 200 may be a controller for a parking assistant system (PAS) of a vehicle.

The ambient condition information transmitted from the user terminal 100 to the vehicle terminal 200 may be transmitted through at least one network of a wired communication network and a wireless communication network, such as Wi-Fi, Bluetooth®, and near field communication (NFC).

The ambient condition information transmitted from the user terminal 100 may be transferred to a Body Control Module (BCM) of a vehicle through a wired/wireless gateway installed in the vehicle, and then to the vehicle terminal 200 through the BCM. Alternatively, the ambient condition information transmitted from the user terminal 100 may be directly provided to the vehicle terminal 200 from the wired/wireless gateway without passing through the BCM unlike the above description.

The vehicle terminal 200 corrects a signal of an ultrasonic sensor by using the current ambient condition information at the current position which is provided from the BCM or directly provided from the wired/wireless gateway as described above.

In detail, the vehicle terminal 200 calculates a sound absorption coefficient for correcting a signal of an ultrasonic sensor by the using ambient condition information at the current position which is acquired from the user terminal 100.

The vehicle terminal 200 determines whether a signal correction of the ultrasonic sensor is needed by comparing the calculated sound absorption coefficient with a preset standard sound absorption coefficient, and performs the correction on the ultrasonic signal based on a result of the determination.

Hereinafter, a detailed configuration and operation for correcting an ultrasonic signal in the vehicle terminal 200 will be described with reference to FIG. 2.

Referring to FIG. 2, the vehicle terminal 200 includes a standard condition setter 210, a reference signal setter 220, a standard sound absorption coefficient calculator 230, a current sound absorption coefficient calculator 240, a correction determiner 250, a sound pressure correction rate calculator 260, an ultrasonic transceiver 270, and an obstacle determiner 280.

The standard condition setter 210 sets a standard condition for setting a reference signal and estimating a standard sound absorption coefficient by using standard ambient conditions (temperature, atmospheric pressure, humidity, and so on) as an input standard ambient condition.

The reference signal setter 220 sets a reference signal which is mapped to information about the input standard ambient condition. The reference signal may be provided using a reference signal corresponding to conditions of room temperature, standard atmospheric pressure of 1 atm, and a relative humidity of 20%.

The standard sound absorption coefficient calculator 230 may calculate a standard sound absorption coefficient based on the standard ambient condition information (temperature, atmospheric pressure, and humidity). In this case, a standard sound absorption coefficient α may be calculated using Equation 1 shown below.

$$α = \frac{{B}_{1} {f}_{r , N} {f}^{2}}{{f}^{2} + {f}_{r , N}^{2}} + \frac{{B}_{2} {f}_{r , O} {f}^{2}}{{f}^{2} + {f}_{r , O}^{2}} + {B}_{3} \frac{{p}_{s}}{{p}_{s 0}} {f}^{2} [ \frac{nepers}{m} ] \qquad ( Equation 1 )$$

Here, f is a frequency (Hz), f_{r,N} is a relaxation frequency of Nitrogen, f_{r,O} is relaxation frequency of Oxygen, pₛ is a local atmospheric pressure (p here means total pressure, not acoustic pressure), pₛ₀ is the standard atmospheric pressure (1 atm), B₁, B₂, and B₃ are variables according to temperature, T is the absolute temperature (T₀=293.15 K is the reference value of T (20° C.)), hr is the relative humidity, and h is the absolute humidity (molar concentration of water vapor) in percent.

The first part of Equation 1 reflects a relaxation characteristic of Nitrogen, the second part of Equation 1 reflects a relaxation characteristic of Oxygen, and the third part of Equation 1 reflects other factors (viscosity and thermal conduction characteristics in general).

In Equation 1, the variables B₁, B₂, and B₃ related to temperatures are expressed by Equations 2, 3, and 4 shown below.

B₁=1.068(T/T₀)^{-5/2}e^{-3352/T} (Equation 2)

B₂=0.01275(T/T₀)^{-5/2}e^{-2239.1/T} (Equation 3)

B₃=1.84×10⁻¹¹\sqrt{T/T₀}(pₛ₀/pₛ) (Equation 4)

The relaxation frequency of Nitrogen f_{r,N} and the relaxation frequency of Oxygen f_{r,O} in Equation 1 are expressed by Equations 5 and 6 shown below.

$$\begin{matrix}{f}_{r , N} = \frac{{p}_{s}}{{p}_{s 0}} {( \frac{{T}_{0}}{T} )}^{1 / 2} ( 9 + 280 {he}^{- 4.17 [ {( {T}_{0} / T )}^{1 / 3} - 1 ]} ) & ( Equation 5 ) \\ {f}_{r , O} = \frac{{p}_{s}}{{p}_{s 0}} ( 24 + 4.04 \times {10}^{4} h \frac{0.02 + h}{0.391 + h} ) & ( Equation 6 )\end{matrix}$$

The absolute humidity h in Equation 1 is expressed by Equation 7 below, and a pressure with a temperature is expressed by Equation 8 below.

$$\begin{matrix}h = {h}_{r} \frac{{p}_{sat} / {p}_{s 0}}{{p}_{s} / {p}_{s 0}} = {p}_{s 0} ( \frac{{h}_{r}}{{p}_{s}} ) ( \frac{{p}_{sat}}{{p}_{s 0}} ) \% & ( Equation 7 ) \\ {log}_{10} [ {p}_{sat} / {p}_{s 0} ] = - 6.8346 {( \frac{{T}_{01}}{T} )}^{1.261} + 4.6151 & ( Equation 8 )\end{matrix}$$

For example, when the standard ambient condition is set as 20° C., 1 atm, and a relative humidity of 10%, the standard sound absorption coefficient is calculated as 0.05 using Equation 1.

The current sound absorption coefficient calculator 240 calculates a current sound absorption coefficient by using the ambient condition information at the current position which is received from the user terminal 100. The calculation of the current sound absorption coefficient is the same as the calculation of the standard sound absorption coefficient in the standard sound absorption coefficient calculator 230. For example, when the current ambient condition is 20° C., 1 atm, and a relative humidity of 60%, the current sound absorption coefficient is calculated as 0.15 using Equation 1.

The correction determiner 250 determines whether a signal correction of an ultrasonic sensor is needed by comparing the standard sound absorption coefficient calculated by the standard sound absorption coefficient calculator 230 with the current sound absorption coefficient calculated by the current sound absorption coefficient calculator 240. For example, the correction determiner 250 determines that the correction of the ultrasonic signal is needed when an error between the standard sound absorption coefficient and the current sound absorption coefficient is a predetermined value or more. The predetermined value may be previously set by a developer and may be changed.

The sound pressure correction rate calculator 260 generates a standard sound pressure decrease curve and a current sound pressure decrease curve by using the preset standard sound absorption coefficient and the calculated current sound absorption coefficient, respectively, when it is determined by the correction determiner 250 that the signal correction is needed. Then, the sound pressure correction rate calculator 260 calculates a sound pressure correction rate according to a propagation distance of an ultrasonic wave by using a ratio of the generated standard sound pressure decrease curve and the generated current sound pressure decrease curve. In this case, the sound pressure correction rate calculator 260 may generate a sound pressure decrease curve by using Equation 9 shown below.

A′Ae^{-ar} (Equation 9)

r is a propagation distance of a sound wave, α is a sound absorption coefficient, A is an initial sound pressure, and A is a sound pressure according to the propagation distance.

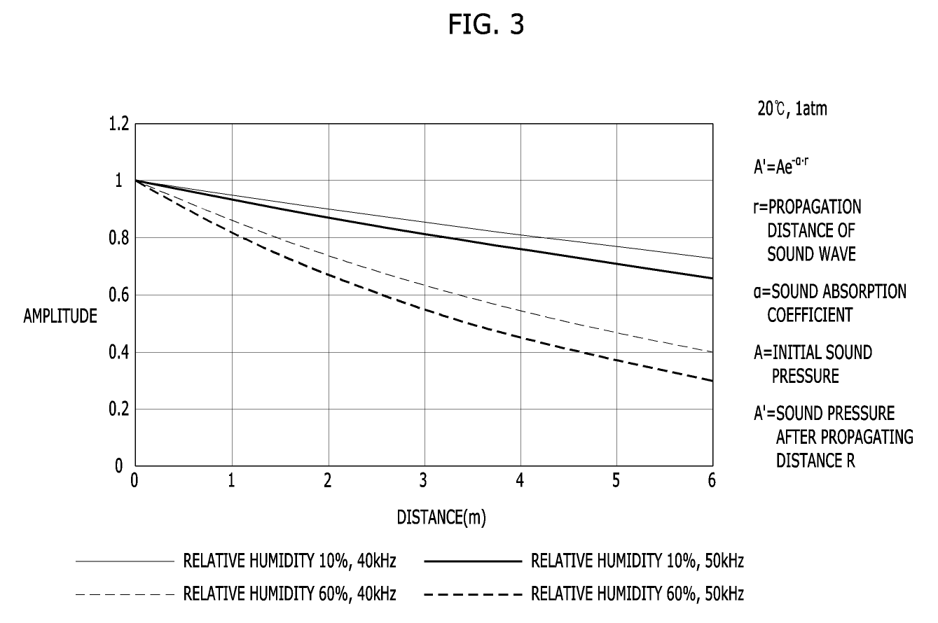

For example, as shown in FIG. 3, an amplitude of a sound pressure decrease curve is subject to a gradual decrease in proportion to an increasing propagation distance of an ultrasonic wave signal. In addition, the sound pressure decrease curve has a different decrease pattern depending on a relative humidity of air and a frequency characteristic of ultrasonic waves.

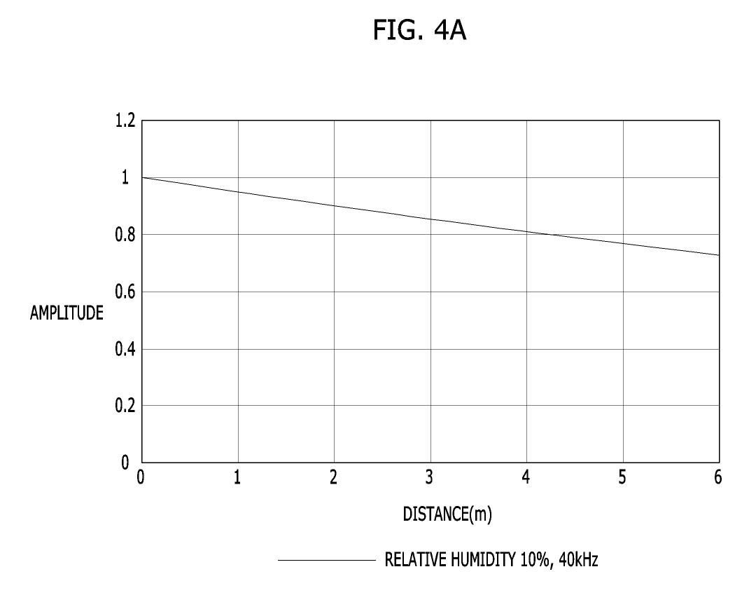

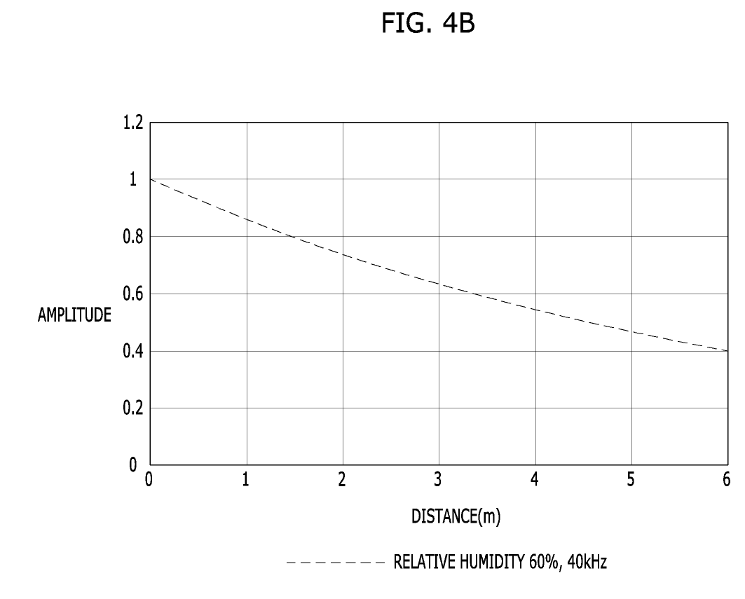

When a standard sound absorption coefficient calculated by the standard sound absorption coefficient calculator 230 is 0.05, a standard sound pressure decrease curve is generated as shown in FIG. 4A according to Equation 9. Similarly, when a current sound absorption coefficient calculated by the current sound absorption coefficient calculator 240 is 0.5, a current sound pressure decrease curve is generated as shown in FIG. 4B according to Equation 9.

The sound pressure correction rate calculator 260 calculates a sound pressure correction rate according to a distance by using a ratio of the generated standard sound pressure decrease curve and the generated current sound pressure decrease curve. In this case, the sound pressure correction rate may be calculated and stored as a single function with respect to a propagation distance of a signal of an ultrasonic sensor, or may be stored as a correction value for each distance value.

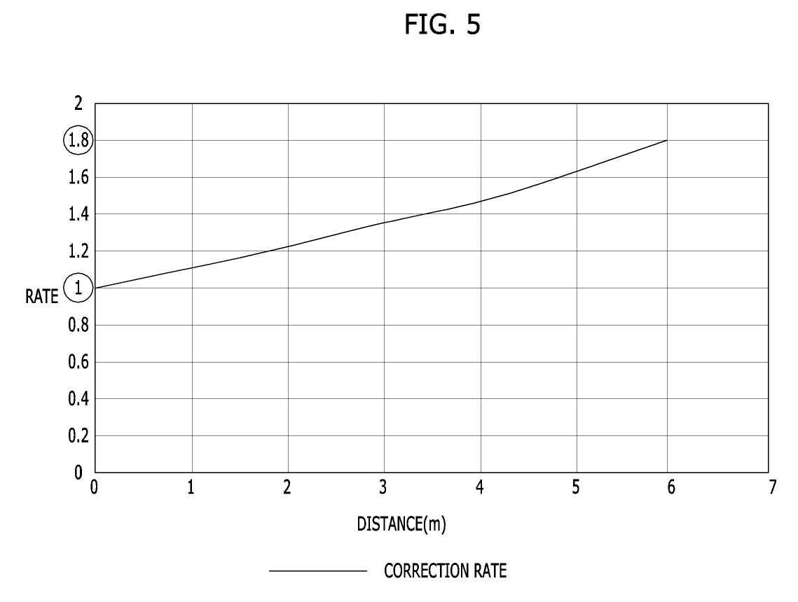

FIG. 5 is a diagram illustrating a sound pressure correction rate according to a distance.

Referring to FIG. 5, a sound pressure correction rate can be seen to increase as a propagation distance of a signal of an ultrasonic sensor increases.

The ultrasonic transceiver 270 transmits a generated ultrasonic wave and receives a signal of the transmitted ultrasonic wave which is reflected from an object.

The ultrasonic transceiver 270 may be formed of a piezoelectric ceramic that may convert mechanical vibration energy into electrical energy or vice versa. When high-frequency electrical energy is applied to the piezoelectric ceramic, the piezoelectric ceramic generates a rapid vibration with the same frequency as the high frequency. When the applied frequency is higher than a predetermined frequency, the piezoelectric ceramic may generate a compression wave, i.e. an ultrasonic wave, which is not audible to a human by a vibration (a sound pressure). In addition, the piezoelectric ceramic may receive an ultrasonic wave and convert the received ultrasonic wave into electrical energy.

The obstacle determiner 280 corrects a received ultrasonic signal of the ultrasonic transceiver 270 according to a distance by using the sound pressure correction rate calculated by the sound pressure correction rate calculator 260. The sound pressure correction rate is set for each propagation distance of an ultrasonic signal. Accordingly, the obstacle determiner 280 calculates a propagation distance of the received ultrasonic signal based on a time at which the received ultrasonic signal is received, and corrects the received ultrasonic wave by multiplying the received ultrasonic signal by the sound pressure correction rate corresponding to the propagation distance of the ultrasonic signal.

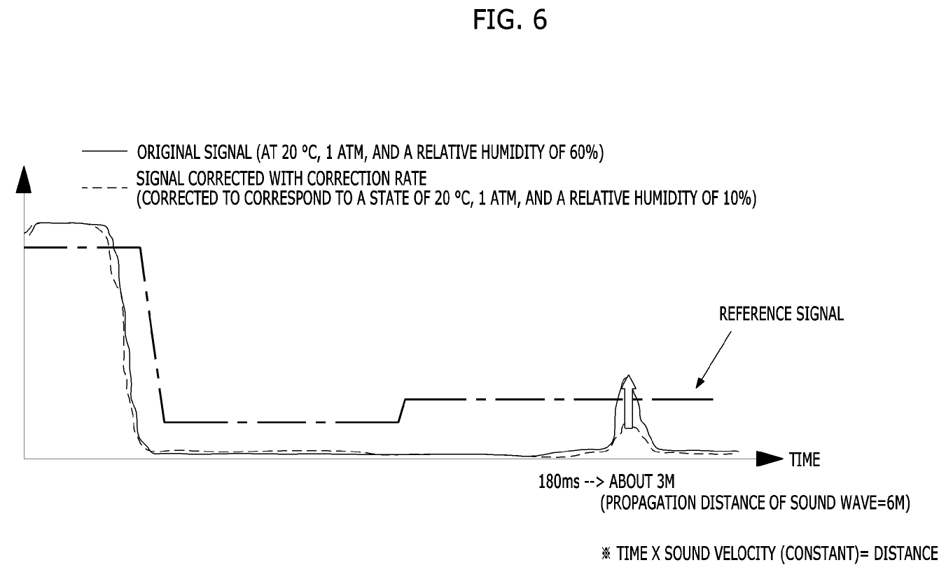

FIG. 6 is a diagram illustrating a result of an original received ultrasonic signal corrected based on a sound pressure correction rate according to an exemplary embodiment.

In a general ultrasonic signal correction method, an acquired data is multiplied by a correction constant such that a value of total data is increased or decreased. However, in the case of a signal reflected from the ground, a propagation distance of the ultrasonic wave is small, so almost no difference occurs in the amplitude of sound pressures depending on an ambient condition (that is, a decrease of sound pressure is not significant).

Therefore, a multiplication of the correction constant and all time domains produces a value exceeding a reference signal, which may lead to a malfunction. According to an exemplary embodiment, a sound absorption coefficient is obtained from temperature, humidity and atmospheric pressure information, and a sound pressure decrease curve according to a distance is obtained by using the obtained sound absorption coefficient. The sound pressure decrease curve is compared with a sound pressure decrease curve obtained based on a standard condition so that correction rate information according to a distance is obtained.

For example, referring to FIG. 6, an ultrasonic signal is corrected by multiplying an original ultrasonic signal measured in a certain ambient condition by a correction rate according to a distance so that a signal which propagated a long distance (a signal traveled to a right side in a time domain) is given a great correction rate, and a signal which propagated a short distance (a signal adjacent to 0 in the time domain) is given a small correction rate to produce a result maximally similar to a result obtained in a standard condition. Accordingly, the system for the determination is constructed by only using a reference signal which is set in a standard condition.

In addition, the obstacle determiner 280 determines whether an obstacle is sensed by using the corrected received ultrasonic signal and the set reference signal. For example, when the corrected received ultrasonic signal has an amplitude greater than that of the set reference signal, the obstacle determiner 280 determines that an obstacle is sensed.

According to an exemplary embodiment, ambient condition information (temperature, humidity, and atmospheric pressure) at the current position is obtained using an application of the user terminal such as a smart phone from a sever of a meteorological administration or a weather observation station, thereby avoiding a need to mount an additional sensor in a vehicle to sense a current weather condition.

In addition, according to an exemplary embodiment, a received ultrasonic signal is corrected by using a sound absorption coefficient to provide sensing of a received signal to be strong in various ambient conditions. In addition, a received ultrasonic signal is sensed by only using a single reference signal which is set based on an input standard ambient condition, thereby reducing a burden to find various reference signals corresponding to different conditions of ambient condition (temperature, humidity, and atmospheric pressure).

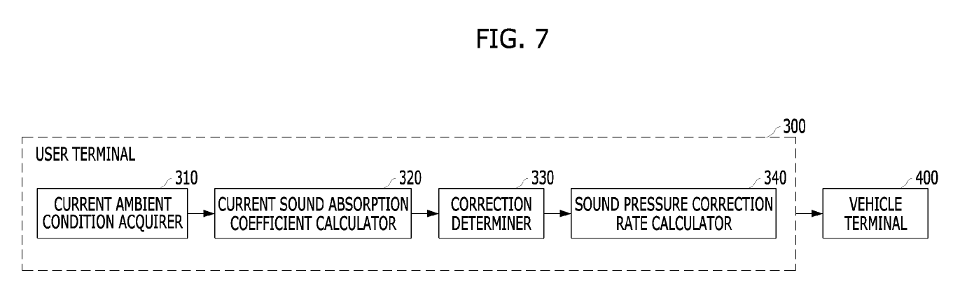

FIG. 7 is a block diagram illustrating a system for correcting a signal of an ultrasonic sensor based on a weather condition according to an exemplary embodiment.

Referring to FIG. 7, a system for correcting a signal of an ultrasonic sensor based on a weather condition according to an exemplary embodiment includes a user terminal 300 and a vehicle terminal 400.

The user terminal 300 acquires information about a current ambient condition at a current position from an external server, calculates a sound absorption coefficient of an ultrasonic sensor in the current weather condition by using the acquired current ambient condition, and determines whether a signal correction of the ultrasonic sensor is needed by using the calculated current sound absorption coefficient. The user terminal 300 may be a mobile communication terminal (for example, a smartphone) possessed by a driver of a vehicle, and the information about an ambient condition may include at least one of temperature, humidity, and atmospheric pressure.

Referring to FIG. 7, the user terminal 300 includes a current ambient condition acquirer 310, a current sound absorption coefficient calculator 320, a correction determiner 330, and a sound pressure correction rate calculator 340.

The current ambient condition acquirer 310 receives information about a current position from a GPS satellite through a GPS module and acquires information about a current ambient condition corresponding to coordinates of the received current position from an external server (not shown). The current ambient condition acquirer 310 may transmit or receive information to and from the external server via a mobile communication, such as 3G and LTE, or a wireless communication, such as Wi-Fi. The external server may be a server of a meteorological administration which is in charge of providing national weather conditions. Alternatively, the external server may be a server of a weather observation station adjacent to a current position.

As an example, the current ambient condition acquirer 310 may acquire the current ambient condition at the current position through an application program (APP) for providing a real-time weather information service.

As another example, the current ambient condition acquirer 310 of the user terminal 300 may have an application installed therein to interoperate with a navigation system of a vehicle to acquire ambient condition information corresponding to a current position of the vehicle which is identified by the navigation system of the vehicle through a server of a weather observation station.

The current sound absorption coefficient calculator 320 calculates a current sound absorption coefficient based on the current ambient condition acquired by the current ambient condition acquirer 310. The calculation of the current sound absorption coefficient is the same as that of the sound absorption coefficient described above using Equation 1, and therefore a detailed description thereof is omitted. For example, when the current ambient condition is 20° C., 1 atm, and a relative humidity of 60%, the current sound absorption coefficient is calculated as 0.15 using Equation 1.

The correction determiner 330 determines whether a signal correction of the ultrasonic sensor is needed by comparing the current sound absorption coefficient calculated by the current sound absorption coefficient calculator 320 with a preset standard sound absorption coefficient. The preset standard sound absorption coefficient is a standard sound absorption coefficient calculated based on a previously input standard ambient condition. The standard ambient condition may be previously input by a developer and may be changed. An exemplary embodiment is described assuming that the standard ambient condition is of room temperature, 1 atm, and a relative humidity of 20%. The standard sound absorption coefficient may be calculated using Equation 1 based on the input standard ambient condition.

The correction determiner 330 determines that a correction of an ultrasonic signal is needed when an error between the standard sound absorption coefficient and the current sound absorption coefficient is a predetermined value or more. The predetermined value may be previously set by a developer and may be changed.

The sound pressure correction rate calculator 340 generates a standard sound pressure decrease curve and a current sound pressure decrease curve using the standard sound absorption coefficient and the current sound absorption coefficient, respectively, and calculates a sound pressure correction rate according to a distance using a ratio of the generated standard sound pressure decrease curve and the generated current sound pressure decrease curve, when the correction determiner 330 determines that a signal correction is needed.

First, the sound pressure correction rate calculator 340 generates a standard sound pressure decrease curve by using the standard sound absorption coefficient and generates a current sound pressure decrease curve by using the current sound absorption coefficient. In this case, the sound pressure correction rate calculator 340 may generate the standard sound pressure decrease curve and the current sound pressure decrease curve using Equation 9.

When a preset standard sound absorption coefficient is 0.05, a standard sound pressure decrease curve is generated as shown in FIG. 4A according to Equation 9. Similarly, when a current sound absorption coefficient calculated by the current sound absorption coefficient calculator 320 is 0.5, a current sound pressure decrease curve is generated as shown in FIG. 4B according to Equation 9.

The sound pressure correction rate calculator 340 calculates a sound pressure correction rate according to a distance by using a ratio of the generated standard sound pressure decrease curve and the generated current sound pressure decrease curve. In this case, the sound pressure correction rate may be calculated and stored as a single function with respect to a propagation distance of a signal of an ultrasonic sensor, or may be stored as a correction value for each distance value.

For example, referring to FIG. 5 illustrating a sound pressure correction rate according to a distance, a sound pressure correction rate can be seen to increase as a propagation distance of a signal of an ultrasonic sensor increases.

The sound pressure correction rate calculated by the sound pressure correction rate calculator 340 is transmitted to the vehicle terminal 400 and is used to correct a signal of the ultrasonic sensor. In this case, the vehicle terminal 400 may receive information for correction including the sound pressure correction rate through a wired/wireless gateway using a wired communication or a wireless communication, such as Wi-Fi and NFC.

The vehicle terminal 400 corrects a signal of the ultrasonic sensor by using the sound pressure correction rate transmitted from the user terminal 300. In detail, the vehicle terminal 400 receives an ultrasonic wave transmitted by the ultrasonic sensor and reflected from an obstacle, and corrects the received ultrasonic signal according to a distance by using the sound pressure correction rate. The sound pressure correction rate has a value set for each propagation distance of an ultrasonic signal. Accordingly, the vehicle terminal 400 calculates a propagation distance of the received ultrasonic signal based on a time at which the ultrasonic signal is received and corrects the received ultrasonic signal by multiplying a sound pressure correction rate corresponding to the propagation distance of the ultrasonic signal received from the ultrasonic sensor.

In addition, the vehicle terminal 400 determines whether an obstacle is sensed by using the corrected ultrasonic signal and a preset reference signal. The reference signal is a signal mapped to a standard ambient condition. In general, the reference signal may be provided using a reference signal corresponding to conditions of room temperature, 1 atm, and a relative humidity of 20%. When the corrected received ultrasonic signal has an amplitude greater than that of the set reference signal, the vehicle terminal 400 determines that an obstacle is sensed.

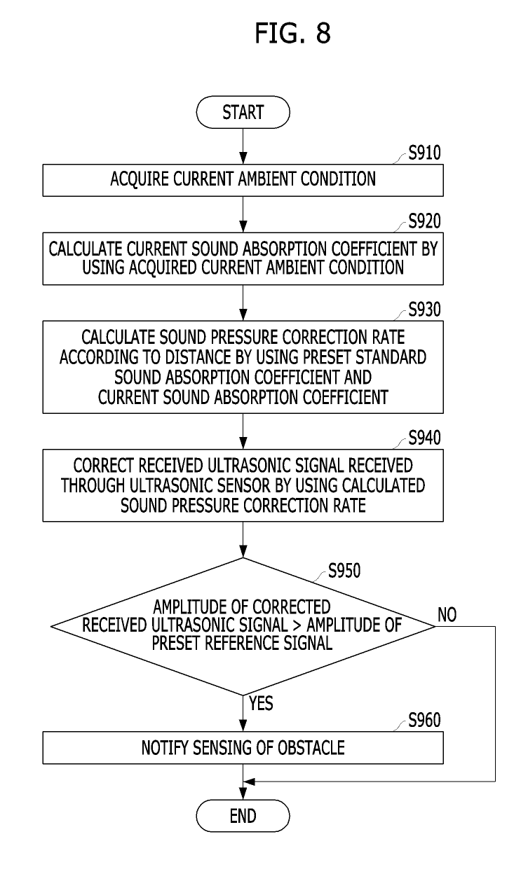

FIG. 8 is a flow chart showing a method of correcting a signal of an ultrasonic sensor based on a weather condition according to an exemplary embodiment.

In order to describe a method of correcting a signal of an ultrasonic sensor based on a weather condition according to an exemplary embodiment, subjects of each operation illustrated in FIG. 8 will be described.

S910 to S960 shown in FIG. 8 may operate in a single module or operate in separate terminals. In an exemplary embodiment, S910 to S930 may be performed by a user terminal (for example, a smart phone) possessed by a driver of a vehicle, and S940 to S960 may operate in a vehicle terminal for a PAS implemented in a vehicle receiving correction information including a sound pressure correction rate from the user terminal.

In an exemplary embodiment, S910 may operate in a user terminal (for example, a smart phone), and S920 to S960 may operate in a vehicle terminal receiving a current ambient condition from the user terminal.

Hereinafter, each operation shown in FIG. 8 will be described in detail.

First, ambient condition information (temperature, humidity, and atmospheric pressure) at a current position are acquired (S910). For example, information about the current position may be received from a GPS satellite through a GPS module, and information about a current ambient condition of the current position may be acquired from an external server by using the received information about the current position.

The external server may be a server of a meteorological administration which is in charge of providing national weather conditions. Alternatively, the external server may be a server of a weather observation station adjacent to a current position.

In an exemplary embodiment, information about an ambient condition at the current position may be acquired through an application program (APP) which provides a real-time weather information service. In an exemplary embodiment, an application program may be configured to interoperate with a navigation system of the vehicle to acquire ambient condition information corresponding to the current position of the vehicle which is identified by the navigation system through an external server.

A current sound absorption coefficient is calculated by using the current ambient condition information acquired in operation S910 (S920). The calculation of the current sound absorption coefficient is the same as that of the sound absorption coefficient described above using Equation 1. For example, when the current ambient condition is 20° C., 1 atm, and a relative humidity of 60%, the current sound absorption coefficient is calculated as 0.15 through Equation 1.

A sound pressure correction rate according to a distance is calculated by using a preset standard sound absorption coefficient and the calculated current sound absorption coefficient (S930). The preset standard sound absorption coefficient may be calculated based on previously input standard ambient condition information. The standard ambient condition information may be previously input by a developer and may be changed. The present invention is described assuming that the standard ambient condition is of room temperature, 1 atm, and a relative humidity of 20%. The standard sound absorption coefficient may be calculated by Equation 1 based on the input standard ambient condition.

Before the calculation of the sound pressure correction rate, it may be determined whether a signal correction of an ultrasonic sensor is needed by comparing the current sound absorption coefficient calculated in operation S920 with the preset standard sound absorption coefficient. When an error between the standard sound absorption coefficient and the current sound absorption coefficient is a predetermined value or more, it is determined that a correction of an ultrasonic signal is needed. The predetermined value may be previously set by a developer and may be changed.

When it is determined that a signal correction of the ultrasonic sensor is needed, a standard sound pressure decrease curve and a current sound pressure decrease curve are generated by using the preset standard sound absorption coefficient and the current sound absorption coefficient, respectively, and a sound pressure correction rate according to a distance is calculated by using a ratio of the generated standard sound pressure decrease curve and the generated current sound pressure decrease curve.

In detail, a standard sound pressure decrease curve is generated by using the standard sound absorption coefficient and a current sound pressure decrease curve is generated by using the current sound absorption coefficient. In this case, the standard sound pressure decrease curve and the current sound pressure decrease curve may be generated using Equation 9.

When a preset standard sound absorption coefficient is 0.05, a standard sound pressure decrease curve is generated as shown in FIG. 4A according to Equation 9. Similarly, when a current sound absorption coefficient is 0.5, a current sound pressure decrease curve is generated as shown in FIG. 4B according to Equation 9.

A sound pressure correction rate according to a distance is calculated by using a ratio of the generated standard sound pressure decrease curve and the generated current sound pressure decrease curve. In this case, the sound pressure correction rate may be calculated and stored as a single function with respect to a propagation distance of a signal of an ultrasonic sensor, or may be stored as a correction value for each distance value.

For example, referring to FIG. 5, a sound pressure correction rate can be seen to increase as a propagation distance of a signal of an ultrasonic sensor increases.

A signal of the ultrasonic sensor is corrected by using the sound pressure correction rate calculated in operation S930 (S940). In detail, an ultrasonic wave transmitted by the ultrasonic sensor and reflected from an obstacle is received, and the received ultrasonic signal is corrected according to a distance by using the sound pressure correction rate. The sound pressure correction rate has a value set for each propagation distance of an ultrasonic signal.

Accordingly, a propagation distance of the received ultrasonic signal is calculated based on a time at which the received ultrasonic signal is received, and the received ultrasonic signal is corrected by multiplying a sound pressure correction rate corresponding to the propagation distance of the ultrasonic signal by the received ultrasonic signal.

Whether an obstacle is sensed is determined by comparing the corrected ultrasonic reception signal with a preset reference signal (S950). The reference signal is a signal mapped to information about a standard ambient condition. In general, the reference signal may be provided using a reference signal corresponding to conditions of room temperature, 1 atm, and a relative humidity of 20%.

When the corrected ultrasonic reception signal has an amplitude greater than that of the set reference signal, it is determined that an obstacle is sensed and a notification of an obstacle sensing is output (S960).

As should apparent from the above, according to the present invention, ambient conditions (temperature, humidity, and atmospheric pressure) at a current position are acquired from a meteorological administration or weather observation station through an application of a user terminal, such as a smart phone, thereby avoiding a need to mount an additional sensor in a vehicle to sense the current weather condition.

In addition, according to an exemplary embodiment, a received signal of an ultrasonic wave is corrected by using a sound absorption coefficient, thereby improving a sensing performance of a received signal in various ambient conditions. In addition, a received ultrasonic signal is sensed by only using a single reference signal which is set based on an input standard ambient condition, thereby reducing a burden to find various reference signals according to different conditions.

The user terminals 100 and 300, vehicle terminals 200 and 400, and/or one or more components of these terminals 100, 200, 300, and 400 may be implemented via one or more general purpose and/or special purpose components, such as one or more discrete circuits, digital signal processing chips, integrated circuits, application specific integrated circuits, microprocessors, processors, programmable arrays, field programmable arrays, instruction set processors, and/or the like. In this manner, the features, functions, processes, etc., described herein may be implemented via software, hardware (e.g., general processor, digital signal processing (DSP) chip, an application specific integrated circuit (ASIC), field programmable gate arrays (FPGAs), etc.), firmware, or a combination thereof. As such, the various terminals 100, 200, 300, and 400 and/or one or more components of thereof may include or otherwise be associated with one or more memories (not shown) including code (e.g., instructions) configured to cause the various terminals 100, 200, 300, and 400 and/or one or more components of thereof to perform one or more of the features, functions, processes, etc., described herein.

The memories may be any medium that participates in providing code to the one or more software, hardware, and/or firmware components for execution. If implemented in soft are, the functions may be stored as one or more instructions or code on a non-transitory computer-readable medium or non-transitory processor-readable medium. Such medium or memories may be implemented in any suitable form, including, but not limited to, non-volatile media, volatile media, and transmission media. Non-volatile media include, for example, optical or magnetic disks. Volatile media include dynamic memory. Transmission media include coaxial cables, copper wire, and fiber optics. Transmission media can also take the form of acoustic, optical, or electromagnetic waves. Common forms of computer-readable media include, for example, a floppy disk, a flexible disk, hard disk, magnetic tape, any other magnetic medium, a compact disk-read only memory (CD-ROM), a rewriteable compact disk (CDRW), a digital video disk (DVD), a rewriteable DVD (DVD-RW), any other optical medium, punch cards, paper tape, optical mark sheets, any other physical medium with patterns of holes or other optically recognizable indicia, a random-access memory (RAM), a programmable read only memory (PROM), and erasable programmable read only memory (EPROM), a FLASH-EPROM, any other memory chip or cartridge, a carrier wave, or any other medium from which information may be read by, for example, a controller/processor.

Although certain exemplary embodiments and implementations of the present invention has been described above, it should be understood that there is no intent to limit the present invention to the particular forms disclosed, but on the contrary, the disclosure is to cover all modifications, equivalents, and alternatives falling within the spirit and scope of the disclosure. Therefore, the exemplary embodiments disclosed in the present application and the accompanying drawings are intended not to limit but to illustrate the technical spirit of the present invention, and the scope of the present invention is not limited by the exemplary embodiments and the accompanying drawings. The protective scope of the present invention should be construed on the basis of the accompanying claims and it should be construed that all of the technical ideas included within the scope equivalent to the claims belong thereto.

What is claimed is:

1. A system for correcting a signal of an ultrasonic sensor according to a weather condition, the system comprising:
a user terminal configured to externally acquire information about an ambient condition at a current position of a vehicle; and
a vehicle terminal configured to calculate a current sound absorption coefficient based on the current ambient condition, determine whether a signal correction of the ultrasonic sensor mounted in the vehicle is needed by comparing the calculated current sound absorption coefficient with a preset standard sound absorption coefficient, and correct a received ultrasonic signal transmitted by the ultrasonic sensor and reflected from an obstacle based on a result determined by the vehicle terminal.

2. The system of claim 1, wherein the user terminal acquires the information about the ambient condition at the current position of the vehicle from a server of a weather observation station which observes a weather condition via a network.

3. The system of claim 1, wherein the vehicle terminal determines that the received signal correction of the ultrasonic sensor is needed when an error between the calculated current sound absorption coefficient and the preset standard sound absorption coefficient is a predetermined value or more.

4. The system of claim 1, wherein the vehicle terminal generates a standard sound pressure decrease curve and a current sound pressure decrease curve by using the preset standard sound absorption coefficient and the calculated current sound absorption coefficient, respectively, calculates a sound pressure correction rate according to a distance by using a ratio of the generated standard sound pressure decrease curve and the generated current sound pressure decrease curve, and corrects the received signal of the ultrasonic sensor by using the calculated sound pressure correction rate.

5. The system of claim 4, wherein the vehicle terminal corrects the received signal of the ultrasonic sensor by computing the received signal of the ultrasonic sensor with the sound pressure correction rate according to a propagation distance of the received ultrasonic signal.

6. A system for correcting a signal of an ultrasonic sensor according to a weather condition, the system comprising:
a user terminal configured to externally acquire information about a current ambient condition at a current position of a vehicle, calculate a current sound absorption coefficient based on the current ambient condition, and determine whether a signal correction of an ultrasonic sensor mounted in the vehicle is needed by comparing the calculated current sound absorption coefficient with a preset standard sound absorption coefficient; and
a vehicle terminal configured to correct a received ultrasonic signal transmitted by the ultrasonic sensor and reflected from an obstacle, based on a result determined by the user terminal.

7. The system of claim 6, wherein the user terminal acquires the information about the ambient condition at the current position of the vehicle from a server of a weather observation station which observes a weather condition via a network.

8. The system of claim 6, wherein the user terminal determines that the signal correction of the ultrasonic sensor is needed when an error between the calculated current sound absorption coefficient and the preset standard sound absorption coefficient is a predetermined value or more.

9. The system of claim 6, wherein the user terminal generates a standard sound pressure decrease curve and a current sound pressure decrease curve by using the preset standard sound absorption coefficient and the calculated current sound absorption coefficient, respectively, calculates a sound pressure correction rate according to a propagation distance of the received ultrasonic signal by using a ratio of the generated standard sound pressure decrease curve and the generated current sound pressure decrease curve when the signal correction of the ultrasonic sensor is determined to be needed, and transmits the calculated sound pressure correction rate to the vehicle terminal via a network.

10. The system of claim 9, wherein the vehicle terminal corrects the received ultrasonic signal by computing the sound pressure correction rate transmitted from the user terminal with the received ultrasonic signal.

11. A method of correcting a signal of an ultrasonic sensor according to a weather condition, the method comprising:
externally acquiring, by a user terminal, information about a current ambient condition at a current position of a vehicle;
calculating, by the user terminal or a vehicle terminal, a current sound absorption coefficient based on the acquired ambient condition information, and determining whether a signal correction of an ultrasonic sensor mounted in the vehicle is needed by comparing the calculated current sound absorption coefficient with a preset standard sound absorption coefficient; and
correcting, by the vehicle terminal, a received ultrasonic signal transmitted by the ultrasonic sensor and reflected from an obstacle based on a result of the determination.

12. The method of claim 11, wherein the user terminal acquires the information about the current ambient condition at the current position of the vehicle from a server of a weather observation station which observes a weather condition via a network.

13. The method of claim 11, wherein the signal correction of the ultrasonic sensor is determined to be needed when an error between the current sound absorption coefficient and the standard sound absorption coefficient is a predetermined value or more.

14. The method of claim 11, wherein in the correcting of the received ultrasonic signal, a standard sound pressure decrease curve and a current sound pressure decrease curve are generated by using the preset standard sound absorption coefficient and the calculated current sound absorption coefficient, respectively, a sound pressure correction rate according to a distance is calculated by using a ratio of the generated standard sound pressure decrease curve and the generated current sound pressure decrease curve, and the received ultrasonic signal is corrected by using the calculated sound pressure correction rate.

15. The method of claim 14, wherein the received ultrasonic signal is corrected by computing the received ultrasonic signal with the sound pressure correction rate according to a propagation distance of the received ultrasonic signal.
